(19) United States
(12) Patent Application Publication
(10) Pub. No.: US 2023/0168163 A1
(43) Pub. Date: Jun. 1, 2023

(54) System and Method for Diffusive Gas Sampling for Collection of VOCs, SVOCs and/or PFAS Chemicals in Air

(71) Applicant: Entech Instruments Inc., Simi Valley, CA (US)

(72) Inventor: Daniel B. CARDIN, Simi Valley, CA (US)

(21) Appl. No.: 18/059,823

(22) Filed: Nov. 29, 2022

Related U.S. Application Data
(60) Provisional application No. 63/264,651, filed on Nov. 29, 2021.

(51) Int. Cl. G01N 1/40

(52) U.S. Cl. CPC G01N 1/405; G01N 2030/143

(57) ABSTRACT

A diffusive sampling device is used for quantitative measurement of chemicals in indoor and outdoor air. The sampling device includes a vial containing a sorbent on the inside bottom of the vial. The sampling device can be thermally vacuum cleaned before transport to the sampling location, and the sorbent can be chosen to allow the collection of either volatile or semi-volatile compounds (VOCs or SVOCs). After a diffusive sampling period (1 hour to 1 month), the vial is closed, and the collected sample is transferred to a laboratory for analysis. Using a thermal vacuum extraction focusing technique, the collected sample is rapidly delivered to a GCMS-compatible preconcentration device including a second sorbent for either split or splitless injection into a capillary based GCMS. No solvents are used during sampler preparation or analysis, and detection limits needed for monitoring of ambient or indoor air can be achieved for thousands of chemicals.

### CROSS-REFERENCE TO RELATED APPLICATION

This application claims the benefit of U.S. Provisional Patent Application No. 63/264,651, filed on Nov. 29, 2021, the entire disclosure of which is incorporated herein by reference in its entirety for all purposes.

### FIELD OF THE DISCLOSURE

The disclosure relates to gas sample collection and, more particularly, air sampling using diffusive vile samplers in indoor and outdoor environments.

### BACKGROUND OF THE DISCLOSURE

Organic chemicals, including lighter volatile through heavier simi-volatile compounds, can be collected by pulling a sample actively through a tube or cartridge containing a sorbent, or by opening up an isolation valve on an evacuated container and allowing the vacuum to draw the sample into the container. In both cases, the equipment needed to perform the sampling is costly, and the ability to do long, time integrated sampling where chemicals collect over time to determine average concentrations can be complicated and can add significantly to the cost. Vacuum canisters have become popular for collecting volatile range compounds, but are ineffective at recovering the heavier, semi-volatile (SVOC) range compounds, and the cost of these canisters and their time integrating inlets can be expensive. PFAS compounds (Per-Fluoro Alkyl Substances) are toxic and carcinogenic compounds that extend the range of volatilities from light VOC through heavy SVOC range, and many can be analyzed using the same sampling and analysis techniques used for VOCs and SVOCs, so for purposes of this discussion, it is understood that PFAS compounds are included in when referring to VOCs and SVOCs herein. Like SVOCs, they can be acid, base, or neutral, so may be ionic at standard pH 7.0. The SVOCs and PFAS (Per-FluoroAlkyl Substances) compounds not recovered by vacuum canister sampling may be even more toxic than VOCs and can often negatively affect the endocrine system in humans, causing health related affects and may even lead to life-ending diseases such as cancer. SVOC/PFAS sampling devices that pull air through cartridges containing Poly Urethane Foam (PUF) or XAD-2 resin will not retain the lighter VOC compounds, and must be solvent-extracted and then blown down to concentrate the extract, all of which takes time, expensive equipment and lab space, and can require solvents that are in themselves unsafe to breathe for extended periods of time. Finally, Thermal Desorption (TD) tubes containing one or more sorbent beds have been used to collect a wide range of chemicals in air, but their consistency from sampler to sampler can be poor, as the pumps used to measure the volume of air passing through them in the field can introduce volume measurement errors, and TD tubes during active sampling can suffer from “Channeling Effects” that cause air to travel faster through gaps created in the sorbent when it cools down from the previous thermal desorption and baking event. Again, these tubes and their field sampling components can be expensive and require significant expertise to use properly.

### SUMMARY OF THE DISCLOSURE

The disclosure relates to gas sample collection and, more particularly, air sampling using diffusive vial samplers in indoor and outdoor environments. A glass vial is prepared with a thin, thermally stable polymeric material coated to the bottom surface to which any number of sorbents can be applied to modify the adsorptive nature of the bottom surface. Solid sorbent material from 15-200 mesh will easily adhere to many polymeric films, and those films comprised of Siloxanes (eg. Polydimethylsiloxane—PDMS) will not break down do create organic or PFAS chemicals, and therefore cannot add to the chemical background even when exposed to Oxygen or Ozone. Using a thermal vacuum cleaning process, the vial containing the polymer base and applied sorbent can be cleaned up to remove any background of VOC/SVOC/PFAS chemicals in the vial, followed by capping off the vial until it can be transferred to a sampling location where it is used to collect an air sample for analysis. At the sampling location, the vial is opened to allow air to diffuse into the vial for a given period of time, and when using vials of the same size (ID and height), the diffusion/collection rates of a very wide range of compounds can be determined. After field collection, the “Diffusive Vial Sampler”, or DVS, is returned to the laboratory for analysis using a thermal vacuum extraction process onto a secondary sorbent containing tube that can be easily interfaced to a GCMS or GCMSMS for quantitative analysis of the collected compounds. This technique greatly simplifies the sampling process, uses no solvents either during sampler preparation or analysis, eliminates inconsistencies caused by dynamic sampling techniques, and increases the number of GC compatible compounds that can be collected and analyzed in air, to include toxic chemicals, endocrine disruptors, and compounds known to have carcinogenic properties.

### BRIEF DESCRIPTION OF THE DRAWINGS

FIGS. 1A-1B are an example DVS sampler according to some embodiments of the disclosure.

FIG. 2 illustrates a cleanup technique used to remove chemicals from the DVS samplers in accordance with some embodiments of the disclosure.

FIGS. 3A-3C illustrate examples of how the DVS samplers can be used to collect air at the sampling location in accordance with some embodiments.

FIGS. 4A-4D illustrate an example of transferring sample collected using the DVS samplers to a secondary focusing device for introduction to a capillary GCMS for analysis according to some embodiments.

FIG. 5 illustrates an example of the final desorption of the Sorbent Pen to a capillary based GCMS or GCMSMS chemical analysis device for analysis according to some embodiments of the disclosure.

### DETAILED DESCRIPTION

In the following description, reference is made to the accompanying drawings which form a part hereof, and in which it is shown by way of illustration specific examples that can be practiced. It is to be understood that other examples can be used, and structural changes can be made without departing from the scope of the examples of the disclosure.

The disclosure relates to gas sample collection and, more particularly, air sampling using diffusive vial samplers in indoor and outdoor environments. A glass vial is prepared with a thin, thermally stable polymeric material coated to the bottom surface to which any number of sorbents can be applied to modify the adsorptive nature of the bottom surface. Solid sorbent material from 15-200 mesh will easily adhere to many polymeric films, and those films comprised of Siloxanes (eg. Polydimethylsiloxane—PDMS) will not break down do create organic or PFAS chemicals, and therefore cannot add to the chemical background even when exposed to Oxygen or Ozone. Using a thermal vacuum cleaning process, the vial containing the polymer base and applied sorbent can be cleaned up to remove any background of VOC/SVOC/PFAS chemicals in the vial, followed by capping off the vial until it can be transferred to a sampling location where it is used to collect an air sample for analysis. At the sampling location, the vial is opened to allow air to diffuse into the vial for a given period of time, and when using vials of the same size (ID and height), the diffusion/collection rates of a very wide range of compounds can be determined. After field collection, the “Diffusive Vial Sampler”, or DVS, is returned to the laboratory for analysis using a thermal vacuum extraction process onto a secondary sorbent containing tube that can be easily interfaced to a GCMS or GCMSMS for quantitative analysis of the collected compounds. This technique greatly simplifies the sampling process, uses no solvents either during sampler preparation or analysis, eliminates inconsistencies caused by dynamic sampling techniques, and increases the number of GC compatible compounds that can be collected and analyzed in air, to include toxic chemicals, endocrine disruptors, and compounds known to have carcinogenic properties.

Diffusive air sampling is a process by which an adsorbent is exposed passively to the indoor or outdoor air sample without the use of pumps or vacuum devices, allowing compounds to diffuse onto the sorbent. In some implementations, if the geometry of the sampling device is chosen properly and remains substantially consistent from one device to the next, the rate of collection can be substantially consistent for any given compound of interest. Diffusive samplers can be significantly less expensive than dynamic samplers, and can require less expertise to use in the field. US EPA Method 325 uses ¼″ OD×5 mm tubes placed vertically during sampling with the inlet facing down to allow compounds to diffuse up and into the sorbent, but the small size of the tube inlet can limit the rate of migration of larger SVOC compounds into the tube, resulting in lower sensitivity. Also, many SVOC and PFAS compounds are attached to particulates in the air, which have thousands of times lower diffusion rates, so those compounds may not be collected during sampling as they tend to settle down under the influence of gravity, whereas individual molecules are not affected significantly by gravity over a relatively short column of air. Using these thermal desorption devices inverted to collect the falling dust can both contaminate the collection tube, and can transfer these dust particles into the GCMS or GCMSMS analyzers upon desorption, which will contaminate these analyzers that are otherwise only designed to accept gas phase chemicals. Using a sampler including geometry of larger size could make it difficult to recover the trapped compounds in the lab, as these sampling devices typically require either a “flow through” thermal desorption that requires a certain linear velocity not maintained using devices with larger cross sections. Diffusive samplers with larger cross sections such as badges and radial samplers are typically solvent extracted to recover the collected compounds. However, when collection sorbents are solvent extracted, only a small fraction of the sample gets injected into a GC or GCMS for analysis in many situations. The resulting dilution can be as high as 50,000:1, severely limiting their sensitivity to those compounds generally in the part per million range. However, in many cases, measurement into the part per billion and often the part per trillion range is needed, and especially when monitoring chemicals that can have long term risk of cancer and in disrupting the normal hormonal system within the human body.

Embodiments of the disclosure include sampling devices that are inexpensive, are easy to use, can perform long term time-integrated sampling to determine average concentrations (true risk factor determinations), and can maximize the sensitivity for VOC/SVOC/PFAS compounds, even those that are pre-adsorbed onto particles in air. For example, Diffusive Vial Samplers (DVS) include glass vials that contain a layer of polymer and/or added adsorbent on the bottom of the vials. Rather than using a solvent or flow through gas to condition the sorbent material prior to sampling, the DVS sampler is connected to a vacuum, and the sorbent is heated to elevated temperatures (e.g., 100-300° C.) to release any compound within the sorbent, transferring them to a vacuum pump that is continuously pumping down on the samplers during thermal conditioning.

To collect compounds in air, the pre-cleaned DVS sampler is taken to the sampling location, the cap is removed for a specific period of time, and then the cap is reattached for return to a laboratory for analysis in some embodiments. If the DVS sampler is placed in a windy location, a screen can be placed over the top of the DVS sampler to arrest any convective sampling, so that compounds must diffuse at standard rates from the entrance of the vial down to the sorbent, for example. A permanent screen may also be added to the top of the DVS that is maintained under the isolation lid to further simplify sampling in known windy or high air movement locations. Alternatively, DVS samplers can be placed in a box or location that acts to eliminate high air movement when placed outside. For indoor air, the DVS sampler can be placed away from a window, or away from any forced air flow (vents, fans, etc.), thereby avoiding the need for an inlet screen or other convection arresting strategies. By using a constant vial geometry (e.g., 20 mL×1.08″ OD, by 2″ Height), the diffusion rates can be consistent between different DVS samplers.

In some embodiments, the DVS samplers can include a variety of sorbents depending on the compounds of interest to be trapped. For example, stronger sorbents can be used in a DVS sampler to collect VOCs in air, and weaker sorbents can be used in a DVS sampler to collect SVOCs. For example, the columns utilized in most US EPA methods are based on the boiling point range of compounds to be analyzed, so typically a thin film column is used to analyze heaver SVOCs (PFAS) compounds, while a thicker film GC column is chosen to separate and analyze lighter VOC (PFAS) compounds. Therefore, using two to three separate DVS samplers to cover VOCs through SVOCs makes sense from a laboratory analysis standpoint, creating consistency with current environmental GCMS methods. As with other sorbent collection methods, VVOC (Very Volatile Organic Compounds) may be a challenge to recover, so vacuum canister or other techniques may still be necessary for the lightest of compounds, but the DVS samplers can be considered for compounds ranging in boiling points from room temperature through the heaviest of GC compatible compounds. Unlike other samplers that can perform thermal extraction or desorption, the DVS can also be used as an LCMS/LCMSMS collection device by adding a small amount of solvent to vial after sample collection, and then transferring an aliquot of the solvent to a vial for LC injection. The very thin layer of sorbent at the bottom of the vial can allow fast and efficient transfer of compounds to the solvent, and the solvent can even adjust the pH to allow recovery of either acids or bases in the DVS sampler.

When performing GC analysis (e.g., GCMS, GCMSMS) the DVS sampling device takes advantage of a new laboratory sample preparation technique called “Flash-VASE”, or Flash—Vacuum Assisted Sorbent Extraction. Flash-VASE is a technique whereby VOC thru SVOC chemicals in a solid matrix are transferred to a tube containing a sorbent by placing the sorbent containing tube (e.g., a Sorbent Pen) at the top of the vial, and then pulling a vacuum on the Pen/vial assembly, followed by heating the vial to “Flash” the compounds into the gas phase and onto the Sorbent Pen. The Flash-VASE process can be done either manually, or on an autosampler whereby just two Sorbent Pens can analyze a full tray of DVS samplers in some embodiments. In an example autosampler implementation, while one Sorbent Pen is performing a Flash-VASE extraction on the next DVS sampler, the other Pen is desorbing the previous DVS sample into a GCMS for analysis. The desorption of the sample into the GCMS can be done either in a split mode or splitless mode in some embodiments, depending on the sensitivity needed. Both the sample collection into the DVS sampler, and the Flash-VASE transfer on the Sorbent Pen are done using a diffusive process, thereby avoiding channeling effects, allowing consistency to be improved dramatically over thermal desorption tubes that were collected individually in the field.

The DVS sampler in particular represents the easiest and perhaps most accurate way to analyze for compounds in the Semi-Volatile range, of which there are thousands found in ambient and indoor air. The inability to collect these compounds reliably and cost effectively has limited the ability for agencies to monitor these dangerous chemicals in both indoor and outdoor air. In addition, the ability to perform long term sampling into a single DVS sampler, such as 1 week or 1 month, can allow average concentrations of these SVOCs to be determined, and therefore assess the potential for diseases resulting from prolonged, chronic exposure. The DVS samplers combined with Flash-VASE extraction and GCMS analysis may change all of this in the future, as the DVS sampler has all the advantages and none of the disadvantages of other sampling devices in use today.

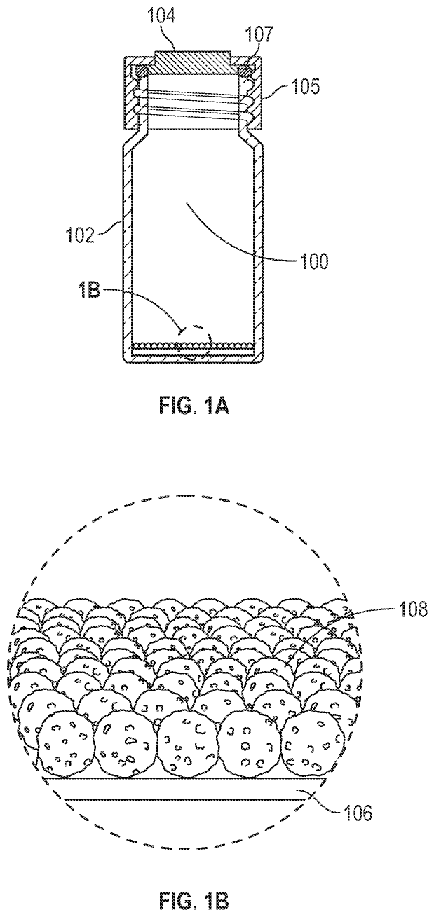

FIGS. 1A-1B are an example DVS sampler 100 according to some embodiments of the disclosure. The example DVS sampler 100 includes a vial 102, a lid 104, a cap 105, O-ring 207 a first sorbent 106, and a second sorbent 108. In some embodiments, the DVS sampler 100 omits the second sorbent 108 shown in FIGS. 1A-1B and includes vial 102, lid 104, cap 105, and first sorbent 106. In some embodiments, second sorbent 108 is a stronger sorbent than first sorbent 106, which can act as a weaker sorbent in some circumstances. In some embodiments, the stronger second sorbent 108 is used when collecting VOCs and/or SVOCs lighter than C14. In some embodiments, when collecting VOCs and/or SVOCs including C14 and heavier and particles containing SVOCs and PFAS, stronger sorbent 108 may be omitted. Adding second sorbent 108 helps in the collection of lighter VOCs, whereas omitting 108 allows collection of heavier SVOCs/PFAS and facilitates washing out of dust after thermal extraction and before the next round of thermal conditioning prior to reuse.

As shown in FIGS. 1A-1B, the sorbents 106 and/or 108 are placed on an interior surface at the bottom of the vial 102. In cases in which second sorbent 108 is used, the second sorbent 108 is made to “stick” to the first sorbent 106 on the vial. For example, first sorbent 106 includes a layer of polymer (e.g., —PDMS, Polydimethylsiloxane). For example, the first sorbent 106 is applied to the bottom of the inside of the vial 102. In some embodiments, first sorbent 106 may be pre-applied to the bottom of inside the vial 102 followed by exposure to the sorbent material of the second sorbent 108. In some embodiments, the second sorbent 108 may be mixed into a solvent diluted coating material (polymer) layer that is added to the vial including the first sorbent 106 at the bottom of the inside of the vial 102, allowing the solvent to evaporate leaving the second sorbent 108 bonded to the bottom of the vial 102 via the first sorbent 106. In either case, the second sorbent 108 is placed in a layer at the bottom of the vial 102 in way that makes the diffusion path from the top to the bottom of the vial 102 consistent from one sampler to the next, for example. Therefore, although many different vial geometries can be used, for example, choosing a geometry and then determining the relative sampling rates (diffusion uptake rates) for a given vial geometry would be advantageous for consistent sampling and analysis. In some cases, a “package” containing multiple smaller vials may be isolated and opened as a group to collect light to heavy compounds with pH adjustment of 1 or more vials to include acid and base compounds before extraction to create a universal sample pack.

In some embodiments, second sorbent 108 is weaker than the first sorbent 106. In this circumstance, a relatively strong sorbent is added to a polymer mixture to form the first sorbent 106, which can be applied to the interior surface of the bottom of the vial 102. Once the carrier solvent for the first sorbent 106 has been removed, leaving the polymer and added stronger sorbent bonded to the bottom of vial 102, the second sorbent 108 can be dusted over the top of the first sorbent 106. Arranging the sorbents 106 and 108 in this way can keep the heavier compounds substantially away from the stronger, first sorbent 106, thereby allowing even a wider range of VOCs to be recovered, for example compounds boiling from 30-80° C., and then 80 to 240° C., and perhaps heavier in a single analysis.

Due to the longer distance from the entrance of the vial to the sorbent relative to badges worn during personal hygiene monitoring, the uptake rate of the DVS samplers can be slower than the uptake rate of personal hygiene monitoring badges, for example. However, since the analysis of the sample is done by thermal desorption, the final amount reaching the GCMS can be 5-100% of the amount sampled, as compared to 0.002-0.05% of the amount sampled with badges due to the typical dilution of 2000:1 or as high as 50,000:1 using solvent extraction and the splitting during GC injection. A lower sampling rate for the DVS samplers has the advantage of eliminating starvation, whereby the local environment around the inlet is not properly purged, causing the air around the inlet to the sampler to be at a reduced concentration and/or pressure. Stated differently, if air at the inlet of the sampler has already been extracted, it cannot be extracted a second time, so the extracted air must move away at a rate that is 5-10 times faster than the rate that chemicals are adsorbed out of the air by the sampler, to avoid the starvation phenomenon. Therefore, the slower sampling rates combined with the much higher sample recovery during analysis is a far better solution than offered by the classical workplace monitoring badges, and especially for Indoor Air Quality (IAQ) determinations where a sufficient flow rate of air over the sampling device cannot be relied upon. In addition, badges are not able to collect dust-bound chemicals, as the plastic enclosure over the badge will not allow passage of the dust through to the collection media. Even non-particle bound SVOCs may stick to the plastic badge enclosure rather than diffusing on into the collection media, and would therefore be lost. The DVS samplers have no such barrier between the air and the collection media, once the lids/caps have been removed to allow the sampling process.

The DVS sampler 100 includes an inert, non-adsorptive/non-absorptive lid 104 to isolate the sampler after cleaning, and during transport to and from the lab. As shown in FIGS. 1A-1B the lid 104 with its sealing O-ring 107 is pressed firmly against the top of the vial 102 using a screw on cap 105, and this combination ensures a leak-tight seal that prevents any collection of VOC/SVOC/PFAS during transportation to and from the sampling location without organic compounds from the environment of the sampler 100 collecting onto the second sorbent 108 and/or first sorbent 106. In some embodiments, the cap 105 and vial 102 include threads to facilitate forming a seal with cap 105. The lid uses a small O-ring 107 to create a seal, but is otherwise a non-absorptive, non-adsorptive material such as stainless steel, or ceramic coated stainless steel. In some situations, the samplers 100 can be labeled with a bar code or other tracking technique to maintain a chain of custody during field sampling, to ensure proper data integrity. Multi-position vial carriers can also be used to track each vial, such as those containing 1-4 positions that hold the vials during transport and sampling, up until they time the vials are thermally or liquid extracted in the laboratory.

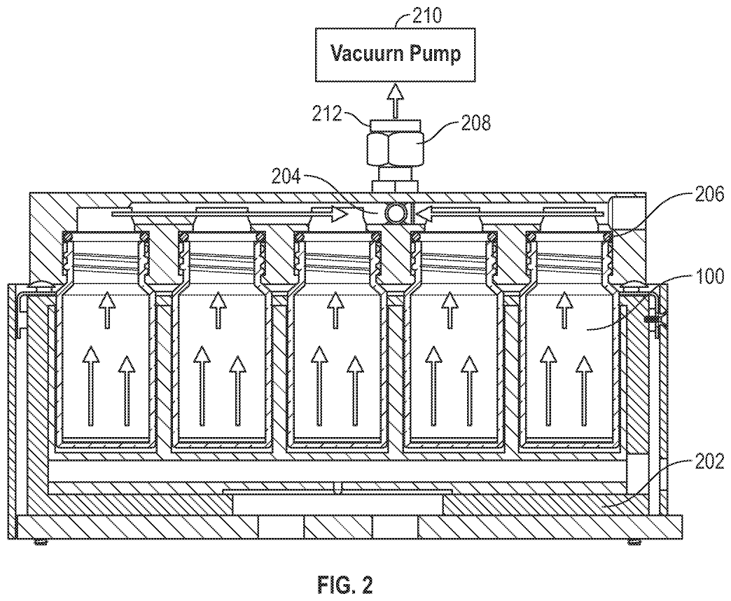

FIG. 2 illustrates a cleanup technique used to remove chemicals from the DVS samplers 100 in accordance with some embodiments of the disclosure. FIG. 2 includes DVS samplers 100, heater 202, and manifold 204. As shown in FIG. 2, the manifold 204 includes a connection 212 to a vacuum pump 210.

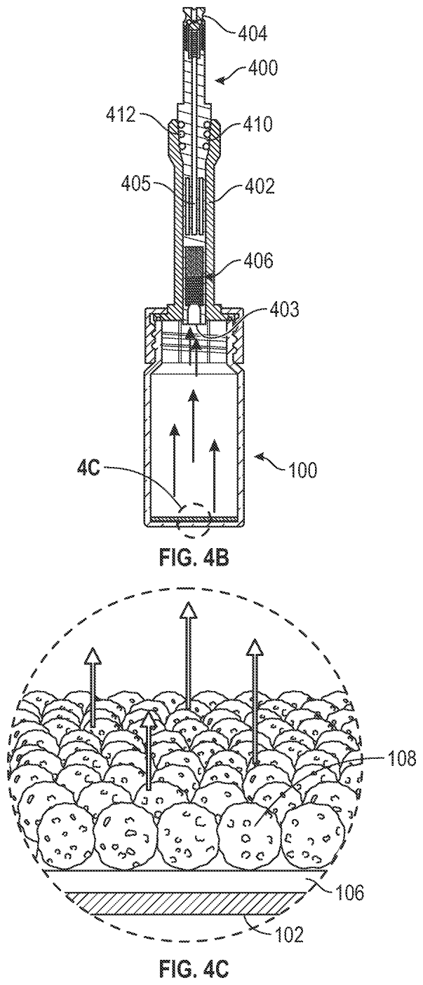

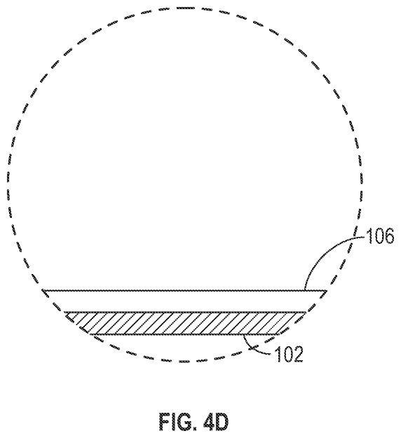

In some situations, the cleanup technique is performed prior to deployment of the samplers 100 in the field or at other times at which it is desirable to remove residual chemicals from the samplers 100. The cleanup technique can be similar to the technique used to recover the chemicals in the lab after sampling, described in more detail below with reference to FIGS. 4A-4D. In the example of FIG. 2, during cleanup the DVS samplers 100 are exposed to higher vacuum and temperatures and for longer periods of time than is the cased during sample recovery for analysis to ensure that virtually nothing is left in the sampler 100 other than what will be added during the next field sampling event.

A heater 202 (e.g., oven or block heater) is used to heat up the sorbent in the vial, while a non-heated manifold 204 creates an O-ring seal at the top of the samplers 100. As shown in FIG. 2, an O-ring 206 (e.g., Silicone or FKM) can be used to seal the top of the samplers 100 and can be placed such that a large number of DVS samplers 100 can be cleaned simultaneously. For example, 10, 20, 30, or more samplers 100 can be cleaned simultaneously.

In some embodiments, the heater 202 can apply more heat to the bottom portions of the samplers 100 than the top portions of the samplers 100. In some embodiments, heater 202 applies heat to the vial 102 evenly or substantially evenly. By heating the samplers 100 and, in particular, the bottom of the samplers 100 where the first sorbent 106 and/or optional second sorbent 108 is located (see FIGS. 1A-1B), the affinity of the chemicals in the sorbent(s) 106 and/or 108 can be reduced to almost zero, allowing them to outgas through the vacuum lines 208 for elimination to the pump 210. The strong vacuum (e.g., 1 Torr or better) relative to the surrounding atmospheric pressure creates a sealing force of several pounds, for example, allowing the DVS samplers 100 to remain sealed to the manifold 204 during cleaning. After cleaning the samplers 100 and while still under vacuum, in some embodiments, the manifold 204 can be picked up to remove all samplers 100 from the heater 202 for transfer to a room temperature tray for rapid cooling. In some embodiments, Nitrogen can be introduced to the samplers 100 through the manifold 204 to release the samplers 100 from the manifold 204. By introducing high purity Nitrogen into the manifold 204, the DVS samplers 100 are ejected from the manifold 204 so they can be quickly sealed with caps 105 and inert liners. In some embodiments, the liners are made of silonite-coated stainless steel and o-rings to form a seal. These liners and O-rings can be cleaned in a heated vacuum vial or chamber.

In some embodiments, the inert liners, o-rings, and/or DVS samplers 100 can be cleaned for re-use using a thermal vacuum cleaning system. For example, the thermal vacuum cleaning system can include a vial, a water supply, one or more heaters, a vacuum source, and a plurality of transfer lines for delivering various fluids (e.g., steam, Nitrogen) to the parts to be cleaned. In some embodiments, cleanup using the vacuum cleaning system can include placing one or more parts in the vial, rinsing the parts with deionized water, steam cleaning the parts, vacuum cleaning the parts, then applying Nitrogen to release the vacuum while avoiding contamination from air in the environment of the cleaning system.

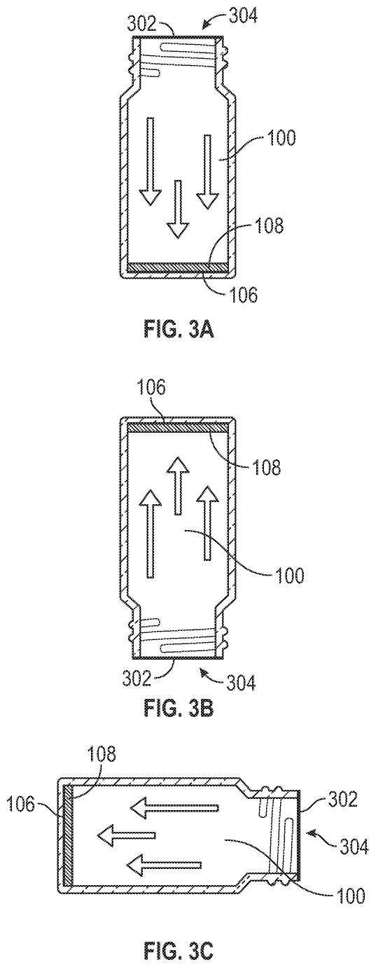

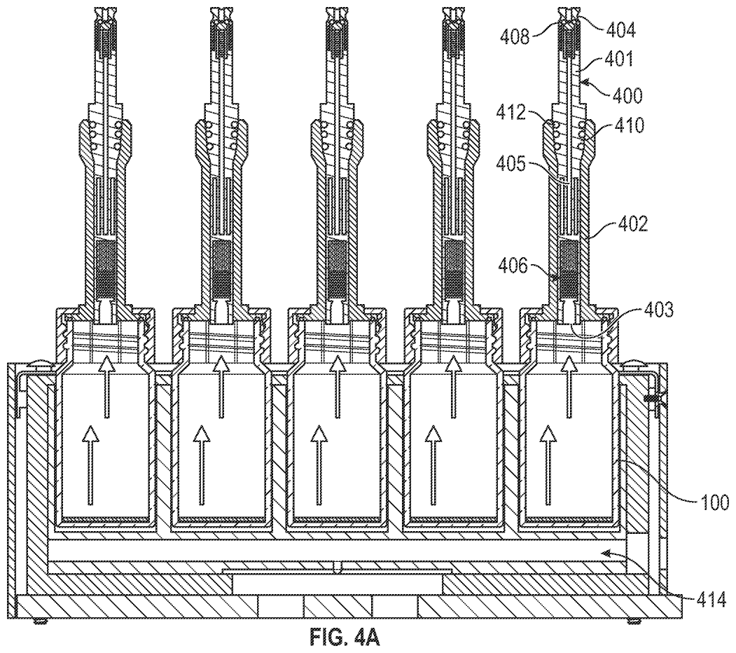

FIGS. 3A-3C illustrate examples of how the DVS samplers 100 can be used to collect air at the sampling location in accordance with some embodiments. As described in more detail below, the DVS sampler 100 can be placed upright as shown in FIG. 3A, upside-down as shown in FIG. 3B, or on its side as shown in FIG. 3C during sampling, depending on the rate and consistency of air movement in the environment of the sampler 100 and on whether the collection of dust and the heavier compounds adsorbed onto them is desired. In some embodiments, DVS sampler 100 is used in a diffusive sampling process.

In some situations, in which the rate of air movement over the sampler 100 is fairly low, then simply removing the isolation lid 104 and cap 105 shown in FIGS. 1A-1B will start the sampling process by allowing ambient air to enter the sampler 100. For indoor air monitoring, a sampling period of 1 to 30 days would provide a representative sampling of the air in that location over the course of the sampling period, for example. For sampling in an area of higher air movement, for example a screen 302 can be added to the top of the sampler 100 to eliminate any convective sampling, which would increase the uptake rate to some unknown amount if allowed to occur. For indoor air, for example, this should not be a problem if positioning the DVS sampler 100 away from a forced air vent or open window. In some cases, it may be necessary to slow down the sampling rate, and this can be done by adding a second lid at the position of screen 302 in FIGS. 3A-3C or at the position of lid 104 in FIGS. 1A-1B that has an opening in it that is smaller than the opening to the sampler 100. This may only be necessary for very long sampling times, or in environments that have a higher organic content in the air. In other cases, using a split injection of up to 200:1 can reduce the amount of sample being delivered to the GC/GCMS, so this remains another way to optimize the amount of sample reaching the GC column or MS (MSMS) detector.

In some situations, the orientation of the sampler 100 has very little effect on the uptake rate of gas phase molecules, as the diffusion of these compounds occurs in all directions randomly. However, sampling rates for heavier chemicals that are stuck to particles in air will be much faster when samplers 100 are positioned with their openings 304 facing up, such as in FIG. 3A. It is generally important to include these particle-bound chemicals when sampling and analyzing air, as these chemicals can easily be inhaled, making absorption into the body extremely likely, for example. However, when the opening 304 of the sampler 100 is facing down, such as in FIG. 3B, as when the DVS sampler is hanging from some support, perhaps near the ceiling, particle introduction can be far less, and potentially 10× or more less. If there is a desire to determine the concentration of these compounds on particles as opposed to those in the gas phase, two DVS samplers 100 could be deployed to a sampling location, one facing up as shown in FIG. 3A and the other facing down as shown in FIG. 3B. However, in some situations, if the goal is to determine which compounds are present, and considering that dust in indoor air may be statistically similar in nature from one location to the next, collecting samples with the sampler 100 openings 304 facing upward as shown in FIG. 3A could be important to determine which locations have higher concentrations of certain chemicals than other locations, and again to include those airborne contaminants that can readily be inhaled and absorbed into the human body. As an intermediate particle collection orientation, a horizontally deployed sampler 100 as shown in FIG. 3C can be considered. After collection of the sample over a 1 hour to 1 month period, the samplers 100 are capped off (e.g., using lid 104 and cap 105 shown in FIGS. 1A-1B) for return to a laboratory for analysis, for example.

FIGS. 4A-4D illustrate an example of transferring sample collected using the DVS samplers 100 to a secondary focusing device 400 for introduction to a capillary GCMS for analysis according to some embodiments. As shown in FIGS. 4A-4D, the focusing device 400 includes a body 401 with an opening 403 to a cavity containing a sorbent 406, a channel 405, a valve 408, a desorption port 410, and seals 412. During the sample transfer process shown in FIGS. 4A-4D, the DVS samplers 100 are disposed in a heater 414 and coupled to the focusing devices 400 by vacuum sleeve 402, as described in more detail below.

For GC analysis, the workup of DVS samplers 100 is very different from that of Polyurethane Foam (PUF) Cartridges or XAD-2 Tubes that require extraction using solvents, followed by a blow down process to concentrate the solvent extract prior to analysis. The implementation of Polyurethane Foam (PUF) Cartridges or XAD-2 Tubes can be very expensive, not at all compatible with most indoor environments, and the use large amounts of solvents during sample workup is considered to be a health concern both for Chemists and for the surrounding environment.

In FIGS. 4A-4D, the DVS samplers 100 are shown attached to a vacuum sleeve 402 whereby a sorbent device 400 (Sorbent Pen) is attached followed by the creation of a vacuum through the top 404 of the Sorbent Pen 400. During a portion of the sample transfer process (e.g., at the beginning), for example, a vacuum can be applied to the system through valves 408 at the top of the Sorbent Pens 400 while DVS samplers 100 are heated with heater 414. In some embodiments, the vacuum source can be fluidly coupled to the DVS samplers 100 through the Sorbent Pens 400, such as through channel 405, sorbent 406, and opening 403. Once the vacuum is drawn in the DVS samplers and Sorbent Pens 400, the vacuum evacuation process can cease by removing the vacuum source or by deactivating the vacuum source. When the vacuum source is removed, for example, the seals 412 and valve 408 of Sorbent Pens 400 can maintain the vacuum in the closed system. During or after pulling the vacuum, the heater 414 can apply heat to the DVS samplers 100, for example. In some embodiments, the sorbents 406 in the Sorbent Pens 400 remain at a lower temperature than the sorbents 106 and/or 108 in the DVS samplers 100 due to the position of the heater such that the heater applies more heat to the sorbents 106 and/or 108 in the DVS samplers 100 than to the sorbent 406 in the Sorbent Pens 400.

FIG. 4C is a close-up of the DVS sampler 100 during sample transfer in accordance with some embodiments. As shown in FIG. 4C, the DVS sampler 100 includes a first sorbent 106 and a second sorbent 108 on the inner surface of vial 102. During sample transfer shown in FIGS. 4A-4B, in the example shown in FIG. 4C, the one or more compounds transfer from the first sorbent 106 and second sorbent 108 to the sorbents 406 in the sorbent pens 400.

FIG. 4D is a close-up of the DVS sampler 100 during sample transfer in accordance with some embodiments. As shown in FIG. 4D, the DVS sampler 100 includes a first sorbent 106 on the inner surface of vial 102 without a second sorbent 108. During sample transfer shown in FIGS. 4A-4B, in the example shown in FIG. 4D, the one or more compounds transfer from the first sorbent 106 or off of particles collected within the DVS sampler 100 to the sorbents 406 in the sorbent pens 400.

By creating a vacuum and then ceasing to pull the vacuum by disconnecting the vacuum pump from the sorbent pen 400 or turning off the vacuum pump without detaching the vacuum pump from the sorbent pen 400, a closed system results whereby heating the sorbent(s) 106 and/or 108 in the DVS samplers 100 while keeping the sorbent 406 in the Sorbent Pen cool causes a very rapid transfer of all or substantially all (e.g., >95%) thermal desorption-compatible compounds from the DVS sampler 100 to the Sorbent Pen 400 in as little as 3-10 or 3-5 minutes. For example, compounds retained in the sorbent(s) 106 and/or 108 of the DVS samplers 100 can diffusively transfer from the sorbent(s) 106 and/or 108 in the DVS samplers 100 to the sorbent 406 in the sorbent pen 400 under vacuum. In some embodiments, pulling the vacuum increases or maximizes the rates of diffusion of the compounds from sorbent(s) 106 and/or 108 to sorbent 406. Diffusively transferring the compounds from the DVS samplers 100 to the sorbent pens 400 in this way can be advantageous because this technique can reduce channeling (e.g., compounds being “pushed” further into sorbent 406 due to flow of carrier fluid during dynamic transfer of compounds), thereby improving recovery of compounds during GCMS analysis and increasing the range of compounds that can be analyzed with this technique. For example, heating sorbent(s) 106 and/or 108 without heating sorbent 406 can enable sampling of thermally labile compounds that cannot be exposed to hot sorbent for a prolonged period of time. Since the sorbent(s) 106 and/or 108 used in the DVS samplers 100 are primarily hydrophobic, the collection of moisture should be minimal, so no attenuation of the response in the GCMS is expected. After the short transfer period, the DVS sampler 100/Sorbent Pen 400 assembly is moved briefly to a room temperature tray where the Sorbent Pen 400 is removed and isolated in a sleeve, awaiting GCMS analysis. Many SVOC/PFAS compounds are bound to particles as salts and are completely non-volatile as such. However, the pH of the DVS media can be made more acidic or more basic just before desorption, such that in one case compounds that are classified as acid/neutral compounds can be recovered, and in the other case the base classified compounds (amines, amides, others) can be deprotonated to bring them to their neutral, non-ionic form, so they can be recovered and analyzed using thermal desorption. The addition of 1 microliter of the appropriate solution can be enough to effect this pH change, using, for example, Citric Acid or NH4OH of the appropriate strength, or other pH modifying solutions.

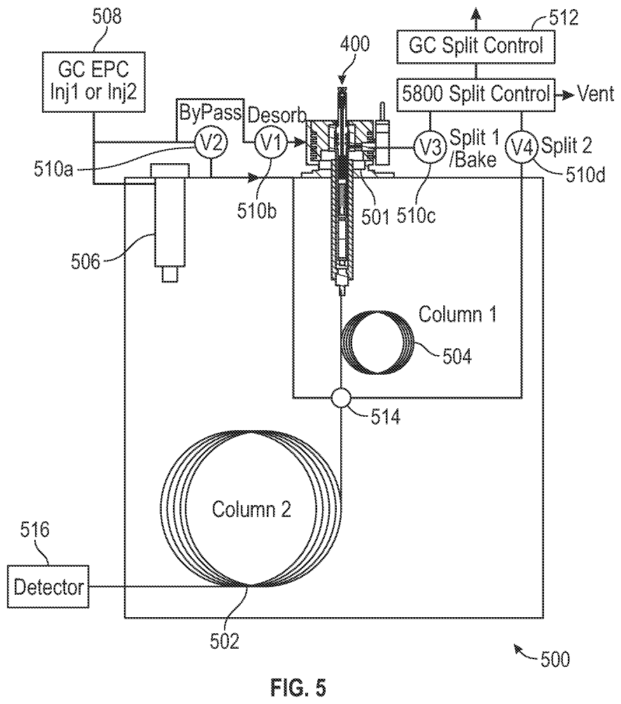

FIG. 5 illustrates an example of the final desorption of the Sorbent Pen 400 to a capillary based GCMS or GCMSMS chemical analysis device 500 for analysis according to some embodiments of the disclosure. As shown in FIG. 5, the chemical analysis device 500 includes thermal desorber 501, carrier fluid supply 506, pressure controller 508, valves 510a through 510d, split controller 512, precolumn 504, junction 514, GC column 502, and detector 516. Sorbent Pen 400 can be inserted into the thermal desorber 501 and heated to a desorption temperature (e.g., 100-500° C.), for example. In some embodiments, after preheating the sorbent pen 400, the sorbent pen 400 can be desorbed using one or more of valves 510a through 510d. For example, carrier fluid can flow from supply 506 through valve 510b into the Sorbent Pen 400 via desorption port 410 and at least a portion of the compounds can be transferred to precolumn 504. In some embodiments, valve 510c and/or valve 510d can be opened to perform a split injection. In some embodiments, valves 510c and 510d can be closed during transfer to the precolumn 504 to perform a splitless injection. In some embodiments, the compounds can be transferred from precolumn 504 to GC column 502 through junction 514. If a split injection is performed with valve 510d, in some embodiments, a portion of the sample exits the system through valve 510d and split control 512 and a portion of the sample proceeds to the GC column 502. In some embodiments, carrier fluid can be introduced through valve 510a once the sample is transferred to the GC column 502 to control the flow of sample and carrier fluid through GC column 502 to detector 502 to conduct a chemical analysis of the sample. In some embodiments, detector 502 is a mass spectrometer. After analysis, in some embodiments, the Sorbent Pen 400 can be heated to a bakeout temperature (e.g., 100-500° C.) and valves 510a and 510c can be opened to remove remaining compounds from the Sorbent Pen 400, allowing the Sorbent Pen 400 to be re-used in a subsequent analysis.

The design of the analysis device 500 allows for either a split injection where perhaps only 1-10% of the sample is transferred to the GC column 502, or a splitless technique where a precolumn 504 is chosen that retains compounds of interest during the desorption of the Sorbent Pen 400. When performing short term sampling (1-8 hours), in some cases a splitless injection may be needed, but for longer sampling times, even compounds down in the part per trillion range may overload the GCMS when using a splitless injection, so in these cases a split injection of 10:1 or up to 200:1 may be necessary. However, using the DVS samplers for area or personal monitoring in industrial environments where concentrations can be in the PPM range, then even a 1-8 hour sampling may require split injections to prevent column overloading, or lids with small sampling holes can be used at the openings of the DVS samplers 100 to slow down the sampling rates as previously described. Delivery of the Sorbent Pens 400 to the system 500 shown in FIG. 5 can be automated using a rail based autosampler, managing up to 8 trays each containing 30 Sorbent Pens 400 (240 Pens total), providing a substantial laboratory throughput for production laboratory settings. Alternatively, in some embodiments, the short DVS to sorbent Pen transfer times of 3-10, or 3-5 minutes can allow just 2 sorbent pens to analyze a 100 or more vials automated by analyzing one pen by GCMS analysis while the other sorbent pen is collecting the next DVS sample, and alternating back and forth until all samples have been analyzed using the 2 sorbent Pen devices. Due to the diffusive nature of the transfer from the DVS sampler 100 to the Sorbent Pen 400 described above with reference to FIGS. 4A-4D, chemicals do not “flow” deep within the Sorbent Pen 400 sorbent 406 (Channeling Effect), so after the desorption into the GCMS 500, levels remaining on the Sorbent Pens 400 are generally less than 1 part in 10,000, thereby eliminating the need for a separate bakeout of the Sorbent Pens 400 prior to reuse. This again suggests this technique for high production laboratories that must achieve high quality instrument blanks to ensure accurate results, for example. In some embodiments, the DVS sampler 100 can also collect samples for analysis by Liquid Chromatography separation and one or multiple stages of Mass Spectrometry detection (LCMS, LCMSMS). In these cases, a small amount of solvent is added to extract the compounds from the polymeric film, and in this case these compounds that are not GC compatible generally have low vapor pressures, so DVS samplers 100 with just first sorbent 106 and no additional second sorbent 108 may be used. In this case, transfer of the LC compatible compounds to the liquid phase can occur quite readily, and many LC compatible solvents are too polar to dissolve the typical (PDMS and other) polymers used to coat the bottom of the DVS samplers 100, thereby allowing the samplers to be used multiple times. Upon exposure of low, high, or non-pH adjusted solvent to the polymer layer, the solvent can be transferred to a vial for automated injection into an LCMS/LCMSMS system. The samplers can then be water rinsed, thermally vacuum conditioned, and sent to the field to collect new samples. This process can occur for dozens of times prior to DVS replacement.

The new sampler can provide a simple yet quantitative and sensitive technique for measuring of VOCs through SVOCs in outdoor air, workplace air, but especially during Indoor Air Quality investigations. The sampler allows the determination of accurate time-weighted averaged concentrations for many compounds that create risk factors for the general population due to their carcinogenic nature, but also for pregnant women and for children during their first several years of life. Many chemicals found in indoor air are endocrine disrupters that can affect fetal and adolescent development, potentially causing Autism and other disorders that have been on the rise over the past several decades, possibly due to the increased level of these endocrine disrupters in the environment. Many researchers believe that exposure to chemicals in food, air, water, and clothing are the reason for these developmental issues, and an improved device for monitoring indoor air quality could be used in combination with epidemiological studies to ascertain which chemicals are most likely responsible for these and other disorders.

The DVS samplers can also be used in other air quality determinations, such as monitoring air in hospitals, office buildings, inside of vehicles, in schools, and other locations. These inexpensive samplers can be used to look for microbial VOCs which can indicate the presence of growing mold inside of buildings, rather than simply looking for spores which may have originated outside rather than from anything growing inside. Mold spores may also be trapped within walls where they are invisible to current measurement techniques, whereas microbial VOCs permeate through walls and would be detected using DVS samplers placed anywhere in the indoor environment. Submarine air can also be ideally monitored using this technology, as can air in low or zero gravity locations on space stations. Cabin air quality on commercial and military aircraft can also be monitored using this low cost yet extremely effective device.

Some embodiments are directed to a method comprising collecting, using a sampling device that includes a vial with a first sorbent coated on an inner surface of the vial, the first sorbent including an adhesive surface, an air sample in a diffusive sampling process, wherein the first sorbent is bonded to the inner surface of the vial wherein the sampling device is compatible with thermal desorption and solvent extraction; sealing the sampling device using an inert cap attached to the sampling device; and using thermal desorption or solvent extraction to deliver one or more compounds of the air sample to a gas chromatograph for chemical analysis. Additionally or alternatively, in some embodiments the sampling device further includes a second sorbent bonded to the adhesive surface of the first sorbent. Additionally or alternatively, in some embodiments the method includes, after collecting the air sample and sealing the sampling device: coupling the sampling device to a preconcentration device including a third sorbent disposed in a cavity, wherein coupling the sampling device to the preconcentration device includes coupling an opening of the cavity to an opening of the sampling device; applying heat, using a heater, to the first sorbent such that more heat is applied to the first sorbent than to the third sorbent; and while applying the heat to the first sorbent, diffusively transferring the one or more compounds of the air sample from the first sorbent to the third sorbent. Additionally or alternatively, in some embodiments using thermal desorption to deliver the one or more compounds of the air sample to the gas chromatograph for chemical analysis includes thermally desorbing the third sorbent. Additionally or alternatively, in some embodiments, the method includes sealing the sampling device and preconcentration device to form a closed system using a valve of the preconcentration device. Additionally or alternatively, in some embodiments the method includes drawing a vacuum in the preconcentration device and the sampling device while the preconcentration device and sampling device are coupled using a vacuum source coupled to a valve of the preconcentration device. Additionally or alternatively, in some embodiments coupling the sampling device to the preconcentration device includes coupling the sampling device and the preconcentration device using a vacuum sleeve around the preconcentration device. Additionally or alternatively, in some embodiments the heat is applied to the first sorbent while the sampling device and preconcentration device form a closed system under vacuum. Additionally or alternatively, in some embodiments the method includes, prior to collecting the air sample in the diffusive sampling process: coupling the sampling device to a manifold; while the sampling device is coupled to the manifold: drawing a vacuum in the sampling device through the manifold while applying heat to the first sorbent.

Some embodiments are directed to a system comprising: a sampling device including a vial with a first sorbent bonded to an interior surface of the vial, wherein the first sorbent includes an adhesive surface, the sampling device configured to diffusively collect an air sample for chemical analysis by gas chromatograph following thermal desorption or solvent extraction, wherein the sampling device is compatible with thermal desorption and solvent extraction; and an inert cap configured to couple to the sampling device to seal the sampling device. Additionally or alternatively, in some embodiments, the sampling device further includes a second sorbent bonded to the adhesive surface of the first sorbent. Additionally or alternatively, in some embodiments the system includes a preconcentration device including a third sorbent disposed in a cavity, wherein the preconcentration device is coupled to the sampling device with an opening of the cavity positioned at an opening of the sampling device, and a heater configured to apply more heat to the first sorbent than to the third sorbent. Additionally or alternatively, in some embodiments the preconcentration device further includes a valve, and while the valve is closed and the sampling device is coupled to the preconcentration device, the system is a closed system. Additionally or alternatively, in some embodiments the system includes a vacuum source, wherein the preconcentration device further includes a valve and the vacuum source is configured to a draw a vacuum in the preconcentration device and the sampling device while the vacuum source is coupled to the valve of the preconcentration device. Additionally or alternatively, in some embodiments, the system includes a vacuum sleeve, wherein the preconcentration device is disposed inside the vacuum sleeve while the preconcentration device is coupled to the sampling device.

Although examples have been fully described with reference to the accompanying drawings, it is to be noted that various changes and modifications will become apparent to those skilled in the art. Such changes and modifications are to be understood as being included within the scope of examples of this disclosure as defined by the appended claims.

1. A method comprising:
collecting, using a sampling device that includes a vial with a first sorbent coated on an inner surface of the vial, the first sorbent including an adhesive surface, an air sample in a diffusive sampling process, wherein the first sorbent is bonded to the inner surface of the vial wherein the sampling device is compatible with thermal desorption and solvent extraction;
sealing the sampling device using an inert cap attached to the sampling device; and
using thermal desorption or solvent extraction to deliver one or more compounds of the air sample to a gas chromatograph for chemical analysis.

2. The method of claim 1, wherein the sampling device further includes a second sorbent bonded to the adhesive surface of the first sorbent.

3. The method of claim 1, further comprising, after collecting the air sample and sealing the sampling device:
coupling the sampling device to a preconcentration device including a third sorbent disposed in a cavity, wherein coupling the sampling device to the preconcentration device includes coupling an opening of the cavity to an opening of the sampling device;
applying heat, using a heater, to the first sorbent such that more heat is applied to the first sorbent than to the third sorbent; and
while applying the heat to the first sorbent, diffusively transferring the one or more compounds of the air sample from the first sorbent to the third sorbent.

4. The method of claim 3, wherein using thermal desorption to deliver the one or more compounds of the air sample to the gas chromatograph for chemical analysis includes thermally desorbing the third sorbent.

5. The method of claim 3, further comprising sealing the sampling device and preconcentration device to form a closed system using a valve of the preconcentration device.

6. The method of claim 3, further comprising drawing a vacuum in the preconcentration device and the sampling device while the preconcentration device and sampling device are coupled using a vacuum source coupled to a valve of the preconcentration device.

7. The method of claim 3, wherein coupling the sampling device to the preconcentration device includes coupling the sampling device and the preconcentration device using a vacuum sleeve around the preconcentration device.

8. The method of claim 3, wherein the heat is applied to the first sorbent while the sampling device and preconcentration device form a closed system under vacuum.

9. The method of claim 1, further comprising, prior to collecting the air sample in the diffusive sampling process:
coupling the sampling device to a manifold; and
while the sampling device is coupled to the manifold:
drawing a vacuum in the sampling device through the manifold while applying heat to the first sorbent.

10. A system comprising:
a sampling device including a vial with a first sorbent bonded to an interior surface of the vial, wherein the first sorbent includes an adhesive surface, the sampling device configured to diffusively collect an air sample for chemical analysis by gas chromatograph following thermal desorption or solvent extraction, wherein the sampling device is compatible with thermal desorption and solvent extraction; and
an inert cap configured to couple to the sampling device to seal the sampling device.

11. The system of claim 10, wherein the sampling device further includes a second sorbent bonded to the adhesive surface of the first sorbent.

12. The system of claim 10, further comprising:
a preconcentration device including a third sorbent disposed in a cavity, wherein the preconcentration device is coupled to the sampling device with an opening of the cavity positioned at an opening of the sampling device; and
a heater configured to apply more heat to the first sorbent than to the third sorbent.

13. The system of claim 12, wherein the preconcentration device further includes a valve, and while the valve is closed and the sampling device is coupled to the preconcentration device, the system is a closed system.

14. The system of claim 12, further comprising a vacuum source, wherein the preconcentration device further includes a valve and the vacuum source is configured to a draw a vacuum in the preconcentration device and the sampling device while the vacuum source is coupled to the valve of the preconcentration device.

15. The system of claim 12, further comprising a vacuum sleeve, wherein the preconcentration device is disposed inside the vacuum sleeve while the preconcentration device is coupled to the sampling device.
